(19) United States
(12) Patent Application Publication
(10) Pub. No.: US 2009/0278274 A1
(43) Pub. Date: Nov. 12, 2009

(54) Method for Monitoring and/or Controlling the Melt Filling of at Least One Cavity

(76) Inventor: Christopher Bader, Neftenback (CH)

Correspondence Address: LAMBERT & ASSOCIATES, P.L.L.C., 92 STATE STREET, BOSTON, MA, 02109-2004, US

(21) Appl. No.: 11/988,477

(22) PCT Filed: Jul. 7, 2006
(86) PCT No.: PCT/EP2006/006652

§ 371 Date: Jan. 8, 2008

(30) Foreign Application Priority Data
Jul. 8, 2005 (DE) 10 2005 032 367.7

(51) Int. Cl. B29C 45/78

(52) U.S. Cl. 264/40.6; 425/144

(57) ABSTRACT

The invention relates to a method for monitoring and/or controlling the melt filling of at least one cavity of an injection molding machine, in particular, by means of a cold channel tool. The invention also monitors the time which is required for the melt to reach the sensor in the cavity and modifies the viscosity of the. melt in the event of variations and/or differentiations in said time.

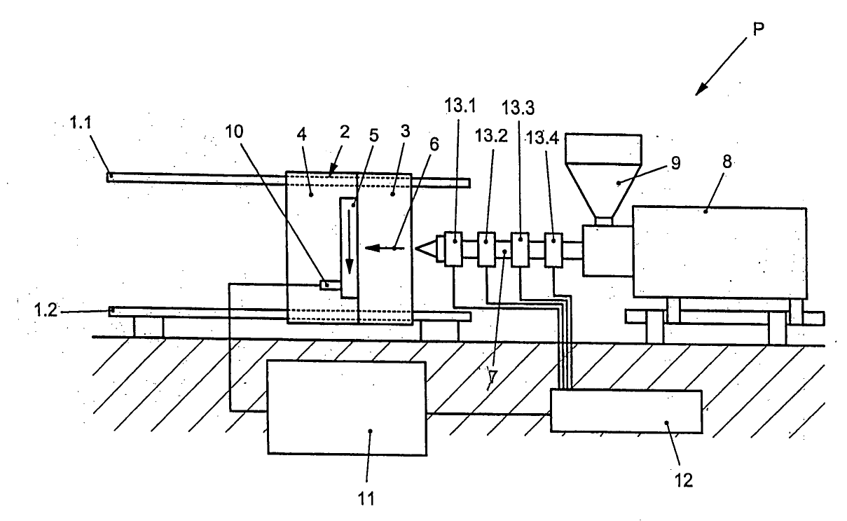

The invention relates to a method for monitoring and/or controlling the melt filling of an injection molding machine, in particular, by means of a cold runner mold as well as a device for the same purpose.

### PRIOR ART

An injection molding process taking place in a injection molding machine inevitably undergoes certain fluctuations due to constant variations in the ambient conditions as well as the quality and consistency of the raw material (melt). These influences ultimately result in variations in the flow characteristics or viscosity of the plastic melt, which lead to differences in the characteristics of the articles produced. For this reason, the traditional assumption that the more precise a process is, the more precise is the ability of the injection molding machine to reproduce parts seems to be, in principle, wrong.

In terms of hot runner molds, this issue was already resolved in accordance with DE 101 12 126 A1 by determining the temperature profile in the cavity and by regulating said temperature profile by influencing the melt temperature in the hot runners.

In the case of cold runner molds, which are still used extensively in injection molding machines, there are essentially only two approaches to be taken:

In the first approach, flow characteristics are precalculated in the distribution system and in the cavities in order to then compensate for certain characteristics by way of the mechanical workings of the distributors. This approach does not actually resolve the abovementioned issue since it does not correct fluctuations in the flow path of the melt.

In the second approach, machine manufacturers attempt to compensate for viscosity fluctuations in the melt even before it enters the mold, or rather in the injection cylinder. However, this is again a matter of open-loop control because influences taking place between the injection devices and the cavity are disregarded.

### OBJECT OF THE INVENTION

The object of the invention is mainly to recognize fluctuations in cold runner molds during injection molding cycles, which can primarily be attributed to fluctuations in the melt, as well as to regulate the melt flow as best as possible.

### SOLUTION TO THE OBJECT

The solution to the object of the invention is to monitor the time needed by the melt to arrive at the sensor and to modify the melt viscosity should variations or differentiations in said time arise.

Said variations must also be measured in the cavity in order to control and compensate for viscosity fluctuations therein. Using the same machine setting and the same runner, the plastic melt reaches a certain flow length within a certain period of time. Said flow length is contingent upon the melt viscosity. High viscosity creates short flow lengths, whereas low viscosity creates longer flow lengths. High viscous melts require more time than low viscous melts to cover the same flow length.

Factors influencing and causing variations in viscosity or melt flow behavior during the injection molding process include the consistency of the raw material, the ambient conditions as well as the heaters of the injection unit. A variation in viscosity can be determined by means of a sensor located in the cavity at the end of the flow path, which detects the arrival of the melt. Said sensor optically measures the temperature of the mold wall, the temperature at the level of the inner cavity wall, the pressure in the cavity, and/or the melt. In the latter event, said sensor could be for example a light conductor, which virtually “sees” the melt. In any event, a change in signal is activated once the melt reaches the sensor. The change in signal is automatically detected so that it can also automatically be determined whether the plastic melt has reached a higher or lower viscosity level due to fluctuations in the material or in the injection molding process.

If the melt requires more time to reach the sensor although the machine setting is the same, said melt has become more viscous. In order to compensate for this increase in viscosity, the viscosity level must be reduced. This reduction could take place by adding a solvent or the like, whereby, however, other characteristics of the melt are influenced. The simplest means of reducing the level of viscosity is to increase the melt temperature. Said increase in temperature may occur at any location within the injection molding machine, by which the melt passes. The simplest location for this to occur is on the injection unit or also on an injection nozzle of the said injection unit. For example, heater bands may be placed around the unit and/or the injection nozzle. It is also possible to use other heating elements. Another possibility is to use the friction energy of the screw in the cylinder of the injection unit to conduct heat into the melt.

If the melt requires less time to reach the sensor although the machine setting is the same, said melt has become less viscous. In order to compensate for this decrease in viscosity, reducing the temperature at the injection unit of the injection molding machine will suffice.

In a preferred embodiment of the invention, the entire process is automated. In the embodiment, the measuring signals (preferably mold wall temperature signals) are automatically detected, and the setpoint values of the cylinder temperatures in the injection unit are transmitted to the machine controller following every cycle by such means as a central computer interface. In this way, closed-loop control is used in a cold runner mold to ensure that variations in viscosity are permanently and fully automatically compensated, so that it can be assumed that the flow characteristics in the injection molding machine remain constant. This, in turn, significantly increases the uniform quality of the injection articles.

The use of the process to which this invention relates, namely the change in viscosity, which has been measured by way of periodic measuring signals, does not have to be restricted to controlling the injection machine—that is, controlling melt viscosity. Said process may also be used in specific cases to monitor variations in viscosity within certain tolerance allowances. Should the cycles exceed the tolerance allowances, the manufactured injection articles are then sorted out as scrap.

### DESCRIPTION OF THE DRAWING

Additional advantages, characteristics and features of the invention become apparent upon reading the following description of a preferred embodiment of the invention in conjunction with the drawing provided. Said drawing provides a schematic side view of an injection molding machine according to the invention.

A cold runner mold (2) is located on the tie bars (1.1, 1.2). Next to the cold runner mold a cavity (5) is formed by openings in a stationary mold plate (3) and a moveable mold plate (4). A cold runner enters the cavity (5) as demonstrated by the arrow (6). Melt is introduced from an injection unit (7) into the cavity (5). The injection unit (7) is connected to an extruder (8), which is fitted with a hopper (9) for receiving plastic material.

The present invention functions as follows:

Upon closing the mold plates (3, 4), the injection unit (7) and the cold runner inject melt into the cavity (5). The melt fills up the cavity (5) and follows a certain flow path until it reaches a sensor (10). The sensor (10) is positioned as close as possible to the end of the flow path and can determine, for example, the temperature of the inner wall of the cavity. Said sensor could be an internal pressure sensor or an optical sensor, which monitors the melt flow.

The sensor (10) is connected to a machine interface (12) by way of an evaluation unit (11). The machine interface is used to control the entire machine. Said machine interface (12) is also linked to a temperature control unit for the melt. In the present embodiment of the invention, the temperature control unit consists of four heater bands (13.1-13.4).

During each cycle, the sensor determines the time needed by the melt to reach it. This time value is relayed to the evaluation unit.

Should the sensor detect a deviation in the flow path time, which exceeds the tolerance allowances, the evaluation unit then transmits a signal to the machine interface indicating the need to modify the temperature of the heater bands. If, for example, it takes the melt longer to travel the flow path, this is an indication that there has been an increase in the viscosity of said melt. Said viscosity can be reduced by increasing the temperature of the induction unit. If, on the other hand, the viscosity of the melt has decreased—that is, said melt travels the flow path to the sensor more quickly—the temperature of the induction unit must then be decreased.

Reference List

| | |
|---|---|
| 1 | tie bar |
| 2 | cold runner mold |
| 3 | stationary mold plate |
| 4 | cavity |
| 5 | arrow |
| 6 | injection unit |
| 7 | extruder |
| 8 | hopper |
| 9 | sensor |
| 10 | evaluation unit |
| 11 | machine interface |
| 12 | heater bands |
| 13 | |
| 14 | |
| 15 | |
| 16 | |
| 17 | |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |
| P | injection molding machine |

1-8. (canceled)

9. A device for regulating the melt filling of at least one cavity within an injection molding machine, comprising:
a pair of tie bars;
a cold runner mold, wherein the cold runner mold is disposed within the tie bars;
a pair of mold plates, wherein the mold plates are located substantially next to the cold runner mold, and whereby a cavity is formed through the opening of the mold plates;
an injection unit, wherein the injection unit is disposed to introduce a quantity of melt into the cavity;
an extruder, wherein the extruder is connected to the injection unit and fitted with a hopper;
a plurality of sensors located substantially within the cavity; and
a machine interface, wherein the machine interface is in data and electrical communication with the sensors through an evaluation unit.

10. The device of claim 9, wherein a temperature control unit is located substantially within the injection unit.

11. The device of claim 10, wherein the temperature control unit further comprises a plurality of heat bands.

12. The device of claim 11, wherein the temperature control unit regulates the viscosity of the quantity of melt injected into the cavity.

13. A method for regulating the melt filling of at least one cavity within an injection molding apparatus utilizing the device of claim 12, the steps of:
(a) closing the mold plates;
(b) injecting the quantity of melt into the cavity by the injection unit and the cold runner mold;
(c) allowing for the quantity of melt to reach the sensor located within the cavity;
(d) recording a time value for the quantity of melt to reach the sensor after completion of an injection cycle;
(e) relaying the time value from the sensor to the evaluation unit after each cycle of injection;
(f) transmitting a signal from the evaluation unit to the machine interface to modify the temperature of the heat bands to ensure uniform flow times; and
(g) adjusting the temperature of the induction unit by way of increasing the temperature of the heat bands to ensure uniform flow times.

14. The method of claim 13, wherein the sensors located substantially within the cavity are disposed to record and process a measurement selected from the group consisting of the temperature of the mold wall, the temperature of the inner cavity wall, the pressure in the cavity, and the pressure of the melt.

15. The method of claim 13, wherein the quantity of heat is conducted into the induction unit by utilizing the heat produced from the friction energy of the transport elements.

16. The method of claim 14, wherein at least one measurement recorded is automatically relayed to the machine interface following each cycle.

17. The method of claim 16, wherein at least one measurement is transmitted to the machine interface following each injection cycle by means of a central computer interface.

18. The method of claim 13, wherein a plurality of set point values for the quantity of melt are transmitted to the machine interface following each of the injection cycles.
